(19) United States
(12) Patent Application Publication
(10) Pub. No.: US 2008/0244305 A1
(43) Pub. Date: Oct. 2, 2008

(54) DELAYED LOCK-STEP CPU COMPARE

(75) Inventors: Rainer Troppmann, Kranzberg (DE); Bernard Fuessl, Moosburg-Aich (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND, GMBH

(21) Appl. No.: 12/042,080

(22) Filed: Mar. 4, 2008

(30) Foreign Application Priority Data
Mar. 30, 2007 (DE) 10 2007 015459.5

(51) Int. Cl. G06F 1/08; G06F 15/00

(52) U.S. Cl. 713/601; 712/30

(57) ABSTRACT

The present invention relates to an electronic device comprising a first CPU, a second CPU, a first delay stage and a second delay stage for delaying data propagating on a bus, a CPU compare unit, and wherein the first delay stage is coupled to an output of the first CPU and a first input of the CPU compare unit, an input of the first CPU is coupled to a system input bus, the second delay stage is coupled to the system input bus and to an input of the second CPU, an output of the second CPU (CPU2) is coupled to the CPU compare unit, and wherein the first CPU and the second CPU are adapted to execute the same program code and the CPU compare unit is adapted to compare an output signal of the first delay stage, which is a delayed output signal of the first CPU, with an output signal of the second CPU. In one embodiment, the present invention relates to a method for lock-step comparison of CPU outputs of an electronic device, in particular a microcontroller, having a dual CPU architecture, the method comprising executing the same program code on a first CPU and a second CPU in response to data provided via a system input bus, delaying an output data of the first CPU by a predetermined first delay to receive a delayed output data, delaying the data to be input to the second CPU by a predetermined second delay, and comparing the output data of the second CPU with the delayed output data of the first CPU.

### CROSS-REFERENCE TO RELATED APPLICATIONS

The present invention claims benefit of German patent application filing number 10 2007 015 459.5, filed on Mar. 30, 2007, which is herein incorporated by reference.

### BACKGROUND OF THE INVENTION

1. Field of the invention

The present invention relates to an electronic device, in particular to a microcontroller, with a dual CPU architecture for comparison of the CPU outputs and to a method for comparison of the CPU outputs of an electronic device with a dual CPU architecture.

2. Description of the Related Art

For security-relevant applications it is known in the art to use two almost identical central processing units (CPUs), one of which operates as the master CPU and the other as the “checker” CPU. Both central processing units execute basically the same program code and receive the same input data. The outputs of the two central processing units are compared to each other in order to identify errors of the master CPU during operation.

Typically, symmetrical dual CPU architectures are used, where both CPUs are of the same type running the program code in lock step. Accordingly, the program code is executed in both CPUs at the same time. Errors which can be detected by conventional dual CPU architectures are for example those due to high-level radiation (as for example a particles or cross talking).

Although the conventional dual CPU architectures are capable of determining errors of at least one of the CPUs, the prior art systems are not capable to detect common cause errors, as for example state flip caused by electromagnetic interference, a voltage drop on the common clock or the supply voltage. Another drawback of conventional dual CPU systems is that, both, the master and the checker CPU are allowed to modify the system state. In particular, using the output of the checker CPU in the system may cause errors and can have a negative impact on the system performance.

### SUMMARY OF THE INVENTION

Embodiments of the present invention generally relate to an electronic device comprising a first CPU, a second CPU, a first delay stage and a second delay stage for delaying data propagating on a bus, a CPU compare unit, and wherein the first delay stage is coupled to an output of the first CPU and a first input of the CPU compare unit, an input of the first CPU is coupled to a system input bus, the second delay stage is coupled to the system input bus and to an input of the second CPU, an output of the second CPU (CPU2) is coupled to the CPU compare unit, and wherein the first CPU and the second CPU are adapted to execute the same program code and the CPU compare unit is adapted to compare an output signal of the first delay stage, which is a delayed output signal of the first CPU, with an output signal of the second CPU. Embodiments of the present invention generally relate to a method for lock-step comparison of CPU outputs of an electronic device, in particular a microcontroller, having a dual CPU architecture, the method comprising executing the same program code on a first CPU and a second CPU in response to data provided via a system input bus, delaying an output data of the first CPU by a predetermined first delay to receive a delayed output data, delaying the data to be input to the second CPU by a predetermined second delay, and comparing the output data of the second CPU with the delayed output data of the first CPU.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified block diagram of a electronic device according to the prior art; and

FIG. 2 is a simplified block diagram of an electronic device according to the present invention.

### DETAILED DESCRIPTION

The present invention may provide an electronic device with a dual CPU architecture capable of detecting all kinds of errors including common cause errors and a method for comparison of CPU outputs in a dual CPU architecture for detecting common cause errors.

Accordingly, an electronic device (e.g. a microcontroller, a digital signal processor (DSP), a microprocessor or the like) is provided which includes a first CPU, a second CPU, a first delay stage and a second delay stage for delaying data propagating on a bus by a first and second delay, respectively, and a CPU compare unit. The first delay stage is coupled to an output of the first CPU and a first input of the CPU compare unit. An input of the first CPU is coupled to a system input bus. The second delay stage is coupled to the system input bus and an input of the second CPU. An output of the second CPU is coupled to the CPU compare unit.

The first CPU and the second CPU execute the same program code and the CPU compare unit is adapted to compare an output signal of the first delay stage with an output signal of the second CPU. The output signal of the first delay stage is a delayed version of the output signal of the first CPU. Accordingly, the electronic device according to the present invention delays the input data to the second CPU by a specific delay, which can be a number of clock cycles or fractions of clock cycles of the system clock. Data in the context of the present invention includes data, as well as any kind of control and address information. So, all signals propagating over the bus may be delayed by the same delay.

Further, the output data, i.e. all signals outputted by the first CPU (the master CPU) are delayed. By delaying both, the input data of the second CPU and the output data of the first CPU, the time shift due to each of the two delays (and if necessary also different run times on the paths) are compensated at the CPU compare unit. The CPU compare unit always compares data belonging to the same operation step of the CPU program codes being executed in either one of the CPUs. The data to be compared by the CPU compare unit includes address and control information as well as any other data relating to the execution of a specific program code.

As the CPU outputs reflect the internal state of the CPU, the operation of the CPUs can be monitored and controlled by comparing the output signals. A specific common cause error, such as a short voltage drop or a glitch in the clock signal will be detected by the electronic device according to the present invention as there is a specific time difference of the execution steps within the CPUs. The two CPUs perform the same operation steps with a slight time shift. So, an error which occurs at the same time in both CPUs, will be reflected in a difference of the output signals. However, as there is no additional delay in the input path of the first CPU, the normal operation of the electronic device (e.g. a microcontroller, DSP etc.) is not affected.

In one embodiment, only the safety critical outputs of the first CPU are delayed by the first delay stage. The execution of the program in the first and the second CPU is in a delayed lock-step. Yet, the output signals of the CPUs arrive at the CPU compare unit in lock-step.

According to an aspect of the present invention, the first delay stage and the second delay stage are adapted to delay the data by the same delay of 0.5, 1, 1.5 or 2 clock cycles. Practical implementations of the an electronic device (e.g. microcontrollers, microprocessors, DSPs or the like) according to the present invention have shown that a time delay between 0.5 and 2 clock cycles of the system clock is appropriate to detect most of the common cause errors. The CPU compare unit may be adapted to report a match or mismatch of the compared output signals to the system. The system may then react appropriately on the reported error.

In one embodiment, the output signal of the first CPU (master CPU) is directly fed to the system before being delayed by the delay stage. This assures that there is no performance loss with respect to the system's normal operation. The output signal of the second CPU is exclusively coupled to the CPU compare unit. The output signal of the second CPU is not used in the system, except for feeding the CPU compare unit (to allow error detection). The internal states of memories or registers are not affected by the second CPU. So, no influence on the system's performance or the system's operation will emanate from the error control mechanism according to the present invention.

The object of the present invention is also achieved by a method for comparison of CPU outputs of an electronic device, in particular a microcontroller or DSP or the like, having a dual CPU architecture. In one embodiment, the method includes the steps of executing the same program code in a first CPU and a second CPU in response to data provided via a system input bus, delaying an output data of the first CPU by a predetermined first delay to receive a delayed output data, delaying the data to be input to the second CPU by a predetermined second delay and comparing the output data of the second CPU with the delayed output data of the first CPU.

Accordingly, only the input signal of the second CPU, which has no impact on the operation of the system as such, is delayed by a certain second time delay. This second time delay (and maybe some additional delays due to the different run times on the paths) introduced into the input path of the second CPU is compensated by a first time delay applied to the output of the first CPU.

Accordingly, the program execution of the CPUs is shifted and the time flow of the program execution in both CPUs is not identical (not in lock step) as in prior art systems. An error occurring in both CPUs at the same time becomes visible in a difference of the output signals. The time first and second delay applied by the respective delay stages may equal and may amount to 0.5, 1, 1.5 or 2 clock cycles. Practical tests revealed that most of the common cause errors can be detected for delays in a range of 0.5 to 2 clock cycles.

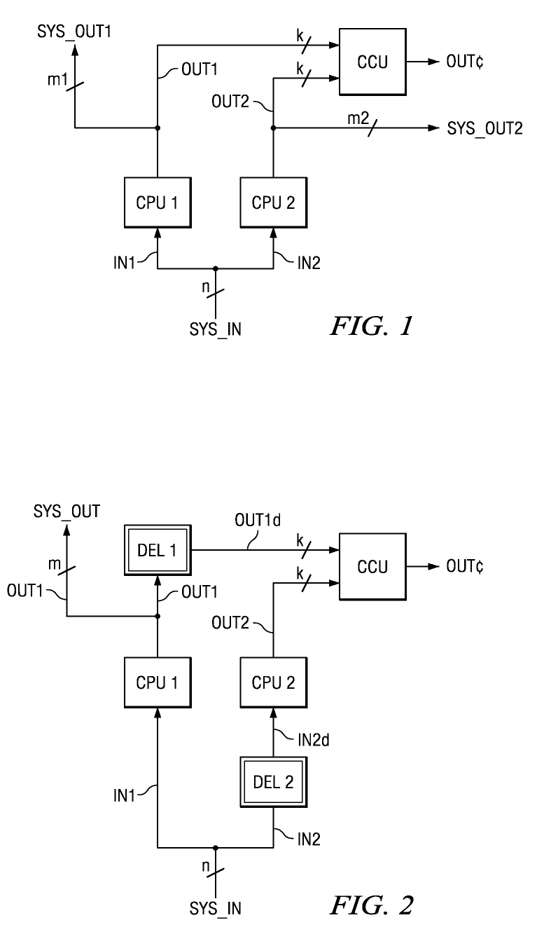

FIG. 1 shows a simplified block diagram of an electronic device according to the prior art. Accordingly, there are two central processing units CPU1, CPU2, receiving the same input data via the system input bus SYS_IN. The system input bus SYS_IN has a width of n lines. The CPUs CPU1, CPU2 are adapted to execute the same program code in a lock-step mode, i.e. both CPUs execute the same step of the program at exactly the same time. The output signals OUT1, OUT2 of the respective CPU is coupled to the CPU compare unit CCU, which compares the output signals OUT1 and OUT2 and detects whether or not the two signals OUT1 and OUT2 are identical. A respective compare output signal OUTC is provided at the output of the CPU compare unit CCU. Both outputs of the central processing units CPU1 and CPU2 are used within the system via output busses SYS_OUT1 and SYS_OUT2 having m1 and m2 lines, respectively.

FIG. 2 shows an electronic device (e.g. a microcontroller, DSP etc.) with a dual CPU architecture according to the present invention. The electronic device includes a first (master) CPU, CPU1 and a second (checker) CPU, CPU2. The system input bus SYS_IN is directly connected to CPU1. The data received at input bus IN1 of CPU1 is used for program execution without delay. The same data is passed to CPU2. However, the data is delayed in delay stage DEL2 by a specific second delay and input via input bus IN2 to CPU2. The output OUT2 of CPU2 is coupled to the CPU compare unit CCU. The output OUT1 of CPU1 is coupled to the first delay stage DEL1. The delayed output signal OUT1d is delayed by a first delay and transmitted to the CPU compare unit CCU. The CPU compare unit CCU compares the output signals OUT1d and OUT2 and detects whether or not the two output signals OUT1d and OUT2 match. A match or mismatch is reported to the system via the compare output OUTc.

According to the present invention, only output OUT1 of the first central processing unit CPU1 is used as system output SYS_OUT. Although both CPUs read the same data (e.g. from the common system memory), only CPU1 can modify the system state (e.g. write to the common system memory). The output of CPU2 is only fed to the CPU compare unit CCU. Since the input data at CPU1 arriving on bus SYS_IN has no delay, and the output OUT1 is directly used for the system without any delay, the overall performance of the system is not impaired. The output OUT2 of the second central processing unit is only used for the comparison with the delayed output signal OUT1d of the first central processing unit. The first and second delays applied by delay stages DEL1 and DEL2 may be adapted to be equal.

In one embodiment, the delay in each of the stages amounts to 0.5, 1, 1.5 or 2 clock cycles. Instead of using the same delays for both delay stages DEL1, and DEL2, the delays may be selected to compensate also for the different run times on the two paths via CPU1 and CPU2. According to this aspect of the invention, the output signals to be compared arrive at the same time at the CPU compare unit CCU, even if the delays via CPU1 and CPU2 are different.

What is claimed is:

1. An electronic device, in particular a microcontroller, comprising:
a first CPU;
a second CPU;
a first delay stage and a second delay stage for delaying data propagating on a bus;
a CPU compare unit; and
wherein the first delay stage is coupled to an output of the first CPU and a first input of the CPU compare unit, an input of the first CPU is coupled to a system input bus, the second delay stage is coupled to the system input bus and to an input of the second CPU, an output of the second CPU (CPU2) is coupled to the CPU compare unit, and wherein the first CPU and the second CPU are adapted to execute the same program code and the CPU compare unit is adapted to compare an output signal of the first delay stage, which is a delayed output signal of the first CPU, with an output signal of the second CPU.

2. The electronic device of claim 1, wherein the first delay stage and the second delay stage are adapted to delay the data by a delay of at least one of 0.5, 1, 1.5 or 2 clock cycles.

3. The electronic device of claim 1, wherein the CPU compare unit is adapted to report a match or mismatch of the compared output signals.

4. The electronic device of claim 1, wherein the output of the first CPU is coupled in parallel to the first delay stage.

5. A method for lock-step comparison of CPU outputs of an electronic device, in particular a microcontroller, having a dual CPU architecture, the method comprising:
executing the same program code on a first CPU and a second CPU in response to data provided via a system input bus;
delaying an output data of the first CPU by a predetermined first delay to receive a delayed output data;
delaying the data to be input to the second CPU by a predetermined second delay; and
comparing the output data of the second CPU with the delayed output data of the first CPU.

6. The method of claim 5, wherein the first delay and the second delay are equal.

7. The method of claim 5, wherein the delay of either the first delay or the second delay amounts to at least one of 0.5, 1, 1.5 or 2 clock cycles.
